(19) United States
(12) Patent Application Publication
(10) Pub. No.: US 2026/0352153 A1
(43) Pub. Date: Nov. 5, 2026

(54) SALINE WATER DESALINATION SYSTEM

(71) Applicants: Daniel PARK, Pohang-si, Gyeongsangbuk-do (KR); SAMIL INDUSTRY CO., LTD., Yeongju-si Gyeongsangbuk-do (KR)

(72) Inventor: Daniel PARK, Pohang-si (KR)

(73) Assignees: Daniel PARK, Pohang-si, Gyeongsangbuk-do (KR); SAMIL INDUSTRY CO., LTD., Yeongju-si, Gyeongsangbuk-do (KR)

(21) Appl. No.: 19/110,131

(22) PCT Filed: Sep. 21, 2023
(86) PCT No.: PCT/KR2023/014333

§ 371 Date: Jan. 8, 2026

(30) Foreign Application Priority Data
Sep. 30, 2022 (KR) 10-2022-0125688
Aug. 8, 2023 (KR) 10-2023-0103274

(51) Int. Cl. H02S 40/42; B01D 1/00; B01D 1/20; B01D 5/00; C02F 1/00; C02F 1/12; C02F 103/08; H02S 40/44

(52) U.S. Cl. CPC H02S 40/425; B01D 1/0064; B01D 1/0082; B01D 1/20; B01D 5/006; C02F 1/008; C02F 1/12; H02S 40/44; C02F 2103/08; C02F 2201/005; C02F 2201/009; C02F 2209/40

(57) ABSTRACT

A saline water desalination system, according to the present invention, comprises: a solar panel unit; a saline water flow unit disposed so as to be spaced apart from the solar panel unit and providing a flow path for saline water for cooling the solar panel unit; and a spray unit for spraying mist for collecting fresh water, by atomizing the saline water which has passed through the flow path, wherein the spray unit enables increased evaporation efficiency of the mist by receiving the saline water of which the temperature has risen by means of the solar panel unit while passing through the flow path.

### TECHNICAL FIELD

The present invention relates to a saline water desalination system, and more particularly, to a saline water desalination system that enables the collection of freshwater from saline water while simultaneously generating solar power.

### BACKGROUND ART

Art Desalination refers to a series of processes for obtaining water with low salinity, such as freshwater, which is suitable for human use, from water with high salinity that is difficult for humans to use, such as seawater.

Desalination requires a lot of energy and thus has low economic efficiency, but in regions where it is difficult to obtain sufficient freshwater naturally, artificial freshwater is produced and used through desalination processes.

Currently, reverse osmosis RO and distillation methods are mainly used in desalination processes.

The reverse osmosis method uses the reverse osmosis phenomenon and has been rapidly increasing in demand recently.

Reverse osmosis is a phenomenon where, when a pressure (reverse osmosis pressure) higher than the osmotic pressure is applied to seawater in a state where seawater maintains equilibrium with a certain pressure difference (osmotic pressure) higher than freshwater across a semipermeable membrane, pure water contained in the seawater moves to the freshwater side.

In the reverse osmosis method, seawater is separated into freshwater and concentrated water, and the concentrated water is discharged back into the sea.

The distillation method involves heating seawater to evaporate it and then condensing the vapor to obtain fresh water.

Currently, methods using fossil fuels to heat seawater are widely used, but recently, methods using solar thermal energy to heat seawater have also been developed to reduce energy consumption.

The reverse osmosis or distillation methods mentioned above have problems of high operating and installation costs and low energy efficiency, so recently, capacitive deionization technology using flow electrodes has been gaining attention for its high energy efficiency in seawater desalination.

However, unlike conventional seawater desalination technologies, capacitive deionization technology uses fluids, which results in a limitation of reduced electrode conductivity, and due to the low conductivity, the amount of salt ions adsorbed onto the electrode material is reduced, leading to poor desalination performance.

### DETAILED DESCRIPTION OF THE INVENTION

### Technical Problem

A purpose of the present invention is to provide a saline water desalination system that generates electricity through solar power generation, circulates saline water using the generated electricity, improves power generation efficiency through the circulating saline water, and simultaneously collects freshwater by spraying and evaporating mist from the atomized circulating saline water.

### Technical Solution

A saline water desalination system according to the present invention may comprise: a solar panel unit; a saline water flow unit spaced apart from the solar panel unit to provide a flow path for saline water for cooling the solar panel unit; and a spray unit for spraying mist to collect freshwater by atomizing the saline water that has passed through the flow path, wherein the spray unit enables increased evaporation efficiency of the mist by receiving the saline water of which the temperature has risen by means of the solar panel unit while passing through the flow path.

In the saline water desalination system of the present invention, the saline water flow unit may be disposed at a back side of the solar panel unit to prevent reduction of light collection efficiency of the solar panel unit due to the saline water.

In the saline water desalination system of the present invention, the spray unit may allow water vapor, from which salt contained in the mist is removed through evaporation, to condense on a bottom surface of the saline water flow unit.

In the saline water desalination system of the present invention, the spray unit may be configured to set at least one of spray direction and spray pressure so that the mist evaporates without reaching the bottom surface of the saline water flow unit.

In the saline water desalination system of the present invention, the saline water flow unit may include a heat exchange element to allow condensation to proceed after the water vapor condenses.

The saline water desalination system of the present invention may further comprise a cooling unit to reduce a temperature increase of the saline water flow unit caused by the solar panel unit, thereby allowing condensation to proceed after the water vapor condenses.

In the saline water desalination system of the present invention, the saline water flow unit may be inclined so that the condensed water generated after the water vapor condenses flows along the bottom surface.

The saline water desalination system of the present invention may further comprise a first collection unit for collecting the freshwater that is the condensed water falling while flowing along the bottom surface.

The saline water desalination system of the present invention may further comprise a second collection unit, provided separately from the first collection unit to collect falling salt contained in the mist during the evaporation process.

In the saline water desalination system of the present invention, the spray unit may be configured to set at least one of spray direction and spray pressure so that the mist is sprayed into a space provided above the second collection unit without reaching a space provided above the first collection unit.

The saline water desalination system of the present invention may further comprise a sensing unit for detecting an environmental condition of the space where the mist evaporates; wherein at least one of the saline water flow unit and the spray unit changes its operating condition based on a detection result of the sensing unit.

The saline water desalination system of the present invention may further comprise: a sensing unit for detecting an environmental condition of a space where the mist evaporates; and an external air supply unit for supplying dry air to the space based on a detection result of the sensing unit.

The saline water desalination system of the present invention may further comprise: a cooling unit to reduce a temperature increase of the saline water flow unit; and a sensing unit for detecting an environmental condition of the space where the mist evaporates; wherein cooling water of the cooling unit is controlled to vary at least one of its circulation speed and temperature based on the detection result of the sensing unit.

The saline water desalination system of the present invention may further comprise: a sensing unit for detecting an environmental condition of a space where the mist evaporates; and a switching valve unit for blocking the flow path supplying the saline water to the spraying unit and draining the saline water when the detection result of the sensing unit is outside a predetermined condition or when the amount of salt extracted through the mist exceeds a predetermined amount.

### Advantageous Effects

According to the saline water desalination system of the present invention, it is possible to increase solar power generation efficiency through saline water while simultaneously collecting freshwater using the evaporation phenomenon of mist atomized from saline water.

Additionally, by supplying temperature-increased saline water to the mist spraying device and optimizing evaporation conditions, the evaporation efficiency of the mist may be increased, thereby enhancing the efficiency of freshwater collection.

### BRIEF DESCRIPTION OF THE DRAWINGS

FIG. 1 is a diagram illustrating a process of supplying freshwater collected through a saline water desalination system according to the present invention to an air dome type smart farm.

FIG. 2 is a block diagram illustrating a saline water desalination system according to the present invention.

FIG. 3 is a diagram illustrating a saline water desalination system according to the present invention.

### BEST MODE FOR CARRYING OUT THE INVENTION

A saline water desalination system according to the present invention may comprise: a solar panel unit; a saline water flow unit spaced apart from the solar panel unit to provide a flow path for saline water for cooling the solar panel unit; and a spray unit for spraying mist to collect freshwater by atomizing the saline water that has passed through the flow path, wherein the spray unit is configured to receive saline water whose temperature has increased as it passed through the flow path due to the solar panel unit, thereby increasing the evaporation efficiency of the mist.

### Mode for the Invention

Hereinafter, specific embodiments of the present invention will be described in detail with reference to the drawings. However, the idea of the present invention is not limited to the embodiments presented, and those skilled in the art who understand the idea of the present invention can easily propose other embodiments, modifications, deletions, etc., within the same idea scope through additions, changes, deletions, etc. These should also be considered to be included within the scope of the present invention idea.

Also, in the drawings of each embodiment, the same reference numerals are used to explain the components with the same function within the same idea scope.

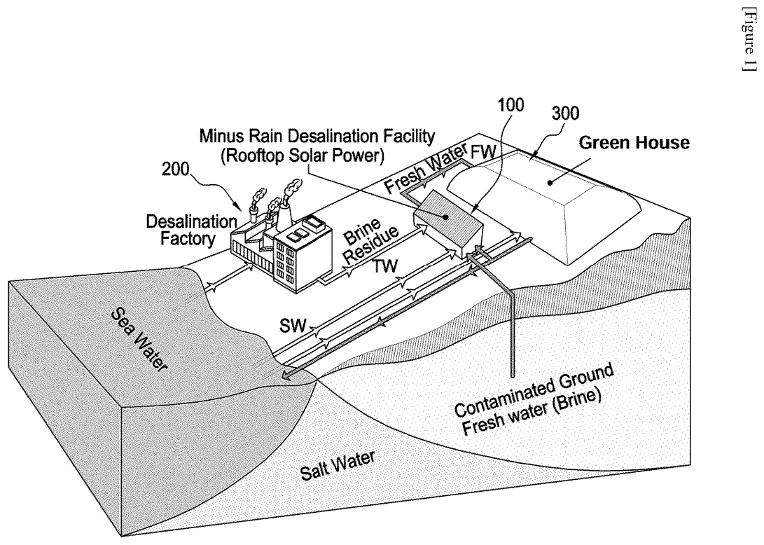

FIG. 1 is a diagram illustrating a process of supplying freshwater collected through a saline water desalination system according to the present invention to an air dome type smart farm.

Referring to FIG. 1, a saline water desalination system 100 according to the present invention may receive treated water TW that has been initially desalinated from a desalination facility 200 or directly receive saline water SW from the sea to collect freshwater FW with minimized salt concentration.

Here, the saline water SW may refer to seawater as shown in the figure, but it is not limited thereto and may refer to all water containing salt, such as groundwater.

The saline water desalination system 100 may generate electricity through solar power generation by a solar panel unit 110, and the generated electricity may be used for power to operate pumps, etc., for circulating the saline water SW.

The saline water desalination system 100 may increase an efficiency of solar power generation and freshwater collection efficiency, etc., through circulation of saline water SW.

The freshwater FW collected by the saline water desalination system 100 may be used as agricultural water, domestic water, etc., and as shown in FIG. 1, the freshwater FW may be used for operating a greenhouse 300 and may also be used as washing water for cleaning the solar panel unit.

The greenhouse 300 may represent a concept encompassing various terms such as a smart farm, vertical farm, or indoor farm.

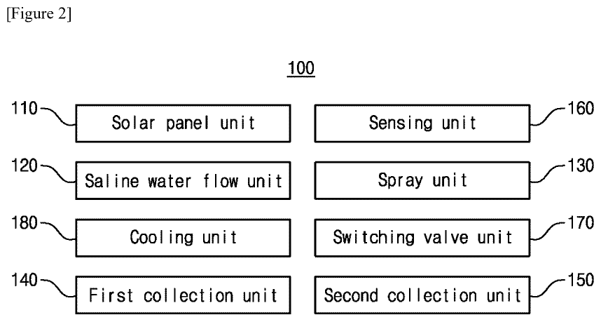

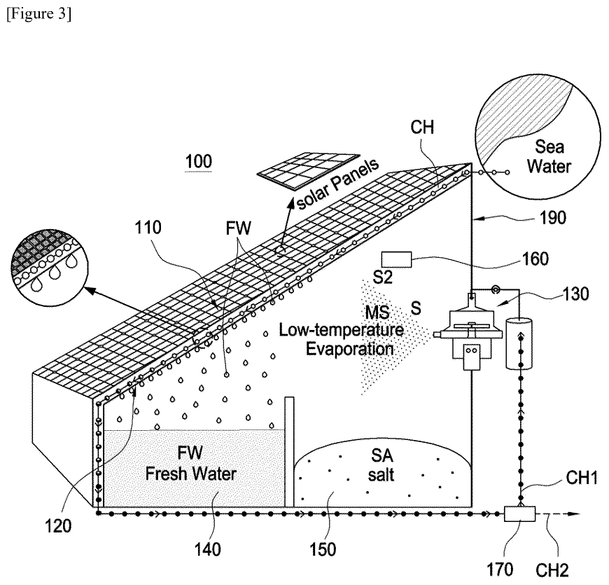

FIG. 2 is a block diagram illustrating a saline water desalination system according to the present invention, and FIG. 3 is a diagram illustrating a saline water desalination system according to the present invention.

Referring to FIGS. 2 and 3, the saline water desalination system 100 according to the present invention may be a facility system that enables solar power generation through the solar panel unit 110 while also allowing collection of freshwater from saline water.

The saline water desalination system 100 may include a solar panel unit 110, a saline water flow unit 120, and a spray unit 130, etc.

Solar power generation is a power generation technology that converts sunlight energy to generate electricity and requires the solar panel unit 110 that generates electricity through a photoelectric effect.

The solar panel unit 110 may include a frame, glass, sealant, solar cells, back sheet, etc., and a known type of solar panel may be applied.

Electricity generated by the solar panel unit 110 may be used as power for operating the saline water desalination system 100 according to the present invention, such as power to operate a pump for circulating the saline water SW and power to operate the spray unit 130.

Also, the electricity generated by the solar panel unit 110 may be used for other purposes or stored in a storage means.

The saline water flow unit 120 may be arranged spaced apart from the solar panel unit 110 to provide a flow path CH for the saline water SW for cooling the solar panel unit 110.

The saline water SW flowing through the flow path CH may be the treated water TW that has been initially desalinated from the desalination facility 200 or the saline water SW supplied from the sea, as explained with reference to FIG. 1.

The saline water flow unit 120 may be disposed at a back side of the solar panel unit 110 to prevent reduction of light collection efficiency of the solar panel unit 110 due to the saline water SW.

The saline water SW flowing through the flow path CH by power means such as a pump or by gravity may cool the solar panel unit 110 and prevent a decrease in power generation efficiency that may occur due to temperature rise caused by light collection.

The spray unit 130 may be a unit that atomizes the saline water SW passing through the flow path CH to spray a mist MS for capturing freshwater.

For example, the spray unit 130 may be an atomizing spray device using a centrifugal fan as disclosed in Korean Patent Application Publication No. 10-2021-0033765, but it is not limited to this, and any device capable of atomizing supply water to spray the mist MS may be applied.

The spray unit 130 may receive the saline water SW whose temperature has increased by the solar panel unit 110 while passing through the flow path CH, thereby increasing evaporation efficiency of the mist MS.

Here, the mist MS sprayed by the spray unit 130 may result in water vapor with salt SA removed through evaporation, and the water vapor may condense on a bottom surface of the saline water flow unit 120.

The saline water desalination system 100 according to the present invention is a system that collects the freshwater by evaporating mist MS sprayed into an internal space S of a chamber unit 190, and to prevent the mist MS from directly reaching the bottom surface of the saline water flow unit 120 without undergoing evaporation, at least one of spray direction and spray pressure of the spray unit 130 may be set.

In other words, the spray unit 130 may be pre-set at least one of the spray direction and the spray pressure to ensure that the mist MS does not directly reach the bottom surface of the seawater flow unit 120 and allows for evaporation to occur.

The water vapor condensed on the bottom surface of the saline water flow unit 120 may flow along the bottom surface, and the saline water flow unit 120 may be manufactured from an element capable of heat exchange to increase extraction efficiency of condensed water FW, such as speed of condensation.

For example, the saline water flow unit 120 may be manufactured from a thermoelectric element capable of heat exchange, such as a Peltier element.

When the saline water flow unit 120 is provided as a thermoelectric element capable of heat exchange, the saline water SW flowing into the spray unit 130 may have its temperature increased by a heating part included in the thermoelectric element.

On the other hand, the saline water flow unit 120 may have its temperature increased by the solar panel unit 110, which may potentially slow down speed of condensation for collecting freshwater.

However, in the present invention, decrease of the speed of condensation may be prevented in advance through a cooling unit 180 for lowering the temperature rise of the saline water flow unit 120 caused by the solar panel unit 110.

The cooling unit 180 may be a unit that supplies or circulates cooling water to cool the saline water flow unit 120, allowing the bottom surface of the saline water flow unit 120 to be cooled.

Also, the cooling unit 180 may include components such as an evaporator that uses a phenomenon of absorbing vaporization heat when liquid refrigerant vaporizes, and the bottom surface of the saline water flow unit 120 may also be cooled through the phenomenon.

The saline water flow unit 120 may be configured at an incline so that the condensed water FW formed after the water vapor condenses may flow along the bottom surface.

The condensed water FW may fall while flowing along the bottom surface, and the falling condensed water FW may be collected in a first collection unit 140.

The first collection unit 140 may be a collection space for collecting the freshwater that is the falling condensed water FW, and may be provided separately from a second collection unit 150 for collecting the salt SA.

The second collection unit 150 may be a collection space for collecting the salt SA falling in case the salt SA contained in the mist MS falls during the evaporation process.

Here, the spray unit 130 may be configured set at least one of the spray direction and the spray pressure so that the mist MS is sprayed into a space S2 provided above the second collection unit 150 without reaching a space S1 provided above the first collection unit 140.

This is based on the principle of collecting freshwater in the present invention. As explained earlier, the saline water desalination system 100 according to the present invention is a system that collects freshwater through evaporating the mist MS sprayed into the internal space S of the chamber unit 190. If the mist MS sprayed from the spray unit 130 directly flows into the first collection unit 140 without evaporating in the space S2 provided above the second collection unit 150, it would result in an increase in salt concentration of the freshwater collected in the first collection unit 140.

Therefore, the spray unit 130 may ensure that evaporation occurs in the space S2 provided above the second collection unit 150 by adjusting at least one of the spray direction and the spray pressure.

Meanwhile, the saline water desalination system 100 according to the present invention may include a sensing unit 160 for detecting an environmental condition of the space where the mist MS evaporates.

The sensing unit 160 may include a temperature sensor for detecting temperature of the space where the mist MS evaporates or a humidity sensor for detecting humidity, etc.

It is evident that the environmental conditions for increasing the evaporation efficiency of the mist MS may be high temperature and low humidity conditions.

For example, if temperature inside the chamber unit 190 detected by the temperature sensor is lower than outdoor temperature, outdoor air may be supplied through an external air supply unit for supplying outdoor air, raising the temperature inside the chamber unit 190.

Also, if humidity inside the chamber unit 190 detected by the humidity sensor is higher than a predetermined humidity value required for mist evaporation, the humidity inside the chamber unit 190 can be lowered by increasing the circulation speed of the cooling water of the cooling unit 180, or actively lowering the temperature of the cooling water of the cooling unit 180 using a chiller unit, thereby lowering the temperature of the condensation surface of the saline water flow unit 120 and increasing the condensation speed of water vapor.

Alternatively, the humidity inside the chamber unit 190 may be lowered by controlling a thermoelectric element capable of heat exchange to lower the temperature of the bottom surface of the saline water flow unit 120, that is, the temperature of the condensation surface where water vapor condenses, thereby increasing the condensation speed of water vapor.

Alternatively, the humidity inside the chamber unit 190 may be lowered by supplying dry outdoor air to the inside of the chamber unit 190 through an external air supply unit that may supply dry outdoor air.

Alternatively, size of the sprayed mist MS may be reduced by changing operating conditions of the spray unit 130.

Here, the methods mentioned above for adjusting the temperature and humidity inside the chamber unit 190 may be applied sequentially or in stages, starting from the method with low energy consumption.

On the other hand, if the humidity inside the chamber unit 190 does not change to below the predetermined humidity value for evaporation despite lowering the humidity inside the chamber unit 190 through such control, the spray amount by the spray unit 130 may be adjusted or the operation of the spray unit 130 may be stopped for a specific time for drying.

Here, stopping the operation of the spray unit 130 may include draining the saline water through a switching valve unit 170 to be described later, in which case the desalination process may be stopped while solar power generation continues.

On the other hand, the saline water desalination system 100 according to the present invention may include the switching valve unit 170 that may cut off the supply of the saline water SW to the spray unit 130 and directly drain the saline water SW under specific conditions.

The switching valve unit 170 may be a valve that blocks the flow path CH1 through which saline water SW is supplied to the spray unit 130 and allows the saline water SW to be drained through the drainage path CH2 when the results detected by the sensing unit 160 deviate from predetermined conditions or when the amount of salt SA extracted through the mist MS exceeds a predetermined amount.

For example, if it is determined that it is unreasonable to lower the humidity value detected by the sensing unit 160 because it is too high, or if the amount of salt collected in the second collection unit 150 exceeds a predetermined amount, the desalination process can be stopped by changing the flow path of saline water SW through the switching valve unit 170.

However, in this case, solar power generation may continue.

On the other hand, at night when solar light collection is not possible, it becomes difficult to supply temperature-increased saline water to the spray unit 130, so in this case, the flow path of saline water SW can be selectively changed by the switching valve unit 170.

In the above, the configuration and characteristics of the present invention have been explained based on the embodiments of the present invention, but the present invention is not limited to this, and it is clear to those skilled in the art to which the present invention pertains that various changes or modifications can be made within the idea and scope of the present invention, and therefore, such changes or modifications are also included within the scope of the attached patent claims.

### REFERENCE NUMERALS

100: Saline water desalination system
110: Solar panel unit
120: Saline water flow unit
130: Spray
140: First collection unit
150: Second collection unit
160: Sensing unit
170: Switching valve unit
180: Cooling unit
190: Chamber unit
SW: Saline water
FW: Freshwater
SA: Salt
MS: Mist

1. A saline water desalination system comprising:
a solar panel unit;
a saline water flow unit spaced apart from the solar panel unit to provide a flow path for saline water for cooling the solar panel unit; and
a spray unit for spraying mist to collect freshwater by atomizing the saline water that has passed through the flow path;
wherein the spray unit enables increased evaporation efficiency of the mist by receiving the saline water of which the temperature has risen by means of the solar panel unit while passing through the flow path.

2. The saline water desalination system of claim 1, wherein the saline water flow unit is disposed at a back side of the solar panel unit to prevent reduction of light collection efficiency of the solar panel unit due to the saline water.

3. The saline water desalination system of claim 1, wherein the spray unit allows water vapor, from which salt contained in the mist is removed through evaporation, to condense on a bottom surface of the saline water flow unit.

4. The saline water desalination system of claim 3, wherein the spray unit is configured to set at least one of spray direction and spray pressure so that the mist evaporates without reaching the bottom surface of the saline water flow unit.

5. The saline water desalination system of claim 3, wherein the saline water flow unit includes a heat exchange element to allow condensation to proceed after the water vapor condenses.

6. The saline water desalination system of claim 3, further comprising a cooling unit to reduce a temperature increase of the saline water flow unit caused by the solar panel unit, thereby allowing condensation to proceed after the water vapor condenses.

7. The saline water desalination system of claim 3, wherein the saline water flow unit is inclined so that the condensed water generated after the water vapor condenses flows along the bottom surface.

8. The saline water desalination system of claim 7, further comprising a first collection unit for collecting the freshwater that is the condensed water falling while flowing along the bottom surface.

9. The saline water desalination system of claim 8, further comprising a second collection unit provided separately from the first collection unit to collect falling salt contained in the mist during the evaporation process.

10. The saline water desalination system of claim 9, wherein the spray unit is configured to set at least one of spray direction and spray pressure so that the mist is sprayed into a space provided above the second collection unit without reaching a space provided above the first collection unit.

11. The saline water desalination system of claim 1, further comprising a sensing unit for detecting an environmental condition of the space where the mist evaporates;
wherein at least one of the saline water flow unit and the spray unit changes its operating condition based on a detection result of the sensing unit.

12. The saline water desalination system of claim 1, further comprising:
a sensing unit for detecting an environmental condition of a space where the mist evaporates; and
an external air supply unit for supplying dry air to the space based on a detection result of the sensing unit.

13. The saline water desalination system of claim 1, further comprising:
a cooling unit to reduce a temperature increase of the saline water flow unit; and
a sensing unit for detecting an environmental condition of a space where the mist evaporates;
wherein cooling water of the cooling unit is controlled to vary at least one of its circulation speed and temperature based on the detection result of the sensing unit.

14. The saline water desalination system of claim 1, further comprising:
a sensing unit for detecting an environmental condition of a space where the mist evaporates; and
a switching valve unit for blocking the flow path supplying the saline water to the spraying unit and draining the saline water when the detection result of the sensing unit is outside a predetermined condition or when the amount of salt extracted through the mist exceeds a predetermined amount.
